(19) United States
(12) Patent Application Publication
(10) Pub. No.: US 2003/0014320 A1
(43) Pub. Date: Jan. 16, 2003

(54) Method of promoting a recording by providing rough mixes over the internet

(75) Inventors: Dacid A. Thompson, Houston, TX (US); Randy L. Twaddle, Houston, TX (US)

Correspondence Address: HARRISON & EGBERT, 412 MAIN STREET, 7TH FLOOR, HOUSTON, TX, 77002, US

(73) Assignee: Roughmix, Inc.

(21) Appl. No.: 09/905,102

(22) Filed: Jul. 16, 2001

(51) Int. Cl. G06F 17/60

(52) U.S. Cl. 705/26

(57) ABSTRACT

A method of promoting a recording, including the steps of creating a rough mix of a recording, digitizing the rough mix, and inputting the digitized rough mix to a web site. The web site is accessible so as to download the rough mix to an individual consumer. The individual consumer can order the recording subsequent to the step of accessing by ordering from an on-line retailer or by ordering through the web site. The rough mix can be either an in-session rough mix or stored rough mix from earlier recordings. The recording can be pre-ordered subsequent to the step of accessing the rough mix.

### BACKGROUND OF THE INVENTION

1. Technical Field of the Invention

The present invention relates to methods of promoting recordings. More particularly, the present invention relates to the use of the Internet for the promotion of recordings. Additionally, and furthermore, the present invention relates to the use of rough mixes obtained during recording sessions so as to promote the recording.

2. Description of the Prior Art

Record companies are primarily marketing, promotion and advertising agencies for musicians. The record company will pay money to get the rights to the records from the musicians for a period of time. The musicians will produce a recording in a studio so as to eventually produce a master tape. The record company will then market the completed recording through the use of radio play, through poster displays, through the sponsorship of tours by the musicians and through music videos. The record company will also provide money for other legitimate promotional expenses. Eventually, the record company will sell records in order to recoup these expenses. The major record labels control their own distributors while independent labels have to find distributors.

During the production of the record, the record company will choose acts that they wish to sponsor and promote. The record company will typically choose the producer of the recording. This producer can control the performance or adjust the finished product of the recording. Recently, producers are becoming more famous and are becoming more directly involved in the final product. Typically, the record company will hire the producer.

When in the studio, the producer and the recording musicians will carry out a creative collaboration. This creative collaboration will typically occur within the recording studio. The record company will continue to monitor the recording as it is going along. Each day, the producer and the musicians will create a rough mix. This rough mix is typically the recording at the end of the day. The producer and/or the musicians will simply ask the engineer for the rough mix at the end of the day. The rough mix is the unequalized sound and the raw tracks from the musicians. It is put into a very rough balance as a matter of reference. The record company will then review the rough mix to make sure the recording is proceeding as desired.

The rough mix will include tracks that will ultimately be retained on the final recording. The music that makes it to the rough mix is the music which is good enough at the end of the day. In certain circumstances, the rough mix can be just the drum track, a scratch vocal or other recordings. Within the music industry, the rough mixes are highly revered. The rough mix is the sound that is truest to the artist's intentions. Some musicians will argue that the concepts of the music are ruined by the producer in the final mix. The ultimate mixing of the various tracks that are recorded in the studio can totally change the nature of the sound of the record. After the final recording is completed, the rough mixes are usually discarded. Typically, the rough mixes are not released to the public.

The record companies are in a great deal of trouble because of the proliferation of the Internet. Many recordings are available for free through web sites such as Napster. The recording industry, through digital recording, allows the musicians to make their CDs at home. Although the major recording labels still break the act, it is often difficult for the majors to come up with innovative ways to break the act. The music industry is highly segmented into a multitude of categories or niches. One only needs to watch a music awards show to see all the different categories of music. For example, commercial music may be divided into the following categories: classical, popular or pop music (often regarded as “top 40”), country western, rock n' roll, jazz, hip hop, rap, urban, adult contemporary, easy listening, new age, punk, soul, funk, Latin, folk and international. Each of general categories may be further divided into subcategories. For example, rock n' roll is often considered to include heavy metal, punk, alternative, “classic” rock and even rhythm and blues. Classical may include opera, chamber, recital, symphonies and choral music. The classification of music is essentially endless. As such, it is often difficult for the record labels to effectively break various acts because of the very fragmented choices available.

It is an object of the present invention to use the rough mixes in order to promote the release of the recording.

It is another object of the present invention to make the rough mixes available over a web site so that individual consumers, through the use of their PCs, can follow the creative process.

It is another object of the present invention to provide a method for promoting a recording which enhances public interest in the recording.

It is another object of the present invention to provide a method of promoting a recording which enhances the sales of the recording.

It is a further object of the present invention to provide a method of promoting a recording which can provide feedback for television and radio productions.

It is another object of the present invention to provide a method of promoting a recording which allows the consumer to pre-order the recording prior to the creation of the final product.

These and other objects and advantages of the present invention will become apparent from a reading of the attached specification and appended claims.

### SUMMARY OF THE INVENTION

As used herein and throughout, the term “rough mix” or the term “rough mixes” is defined as any performances recorded or otherwise embodied on storage media other then the particular tape or other storage medium embodying a master recording or any duplicate thereof, including individual tracks of multi-track recordings (whether contained in a master recording or not). Combinations of such individual tracks, “scratch vocal” tracks (individually or in combination with other tracks), unissued mixdowns of multi-track recordings, session tapes, remixes, rough takes, outtakes and any other recordings or embodiments of performances which have not been and are not manufactured, sold or licensed as a master would be considered a “rough mix”.

The present invention is a method of promoting a recording which comprises the steps of: (1) creating a rough mix of a recording; (2) digitizing the rough mix; and (3) inputting the digitized rough mix to a web site. The web site can be accessed so as to download the rough mix on a computer terminal of a consumer. The consumer can order the recording subsequent to the step of accessing. The consumer can either access the web site in order to enter an order for the recording or access an on-line retailer for the purpose of ordering the recording from the on-line retailer. In other circumstances, the consumer can pre-order the recording subsequent to the step of accessing and prior to the completion of the recording. This pre-order can be directed toward the record company that is promoting the recording.

The web site can be used so as to store a plurality of the rough mixes. The rough mix can either be an in-session or an in-the-vault rough mix. The rough mix will comprise a plurality of tracks that are recorded during a selected period of time and prior to the production of the final recording. The consumer may, if necessary, pay a fee in order to download the rough mix.

The present invention further comprises the steps of creating a radio program having a rough mix comprised therein. A password can be announced during the radio program which is identifiable to an origin of the radio program, such as affiliate location. The web site can be accessed with the password so as to download the rough mix played during the radio program.

Alternatively, the step of creating a rough mix can comprise creating a television program having the rough mix therein. The password can be announced during the television program. This password is identifiable to an origin of the television program, such as a particular station or a particular area. This password allows the web site to be accessed so as to download the rough mix shown during the television program into the consumer's computer. The radio and television programs can be used so as to promote products and services other than the final recording.

As used herein, the rough mix can also include comments, images and music related to the particular rough mix. The web site can include a directory of resources for obtaining (i.e. purchasing and/or rental) the recording.

### BRIEF DESCRIPTION OF THE SEVERAL VIEWS OF THE DRAWINGS

FIG. 1 is a block diagram showing the method in accordance with the teachings of the present invention.

### DETAILED DESCRIPTION OF THE INVENTION

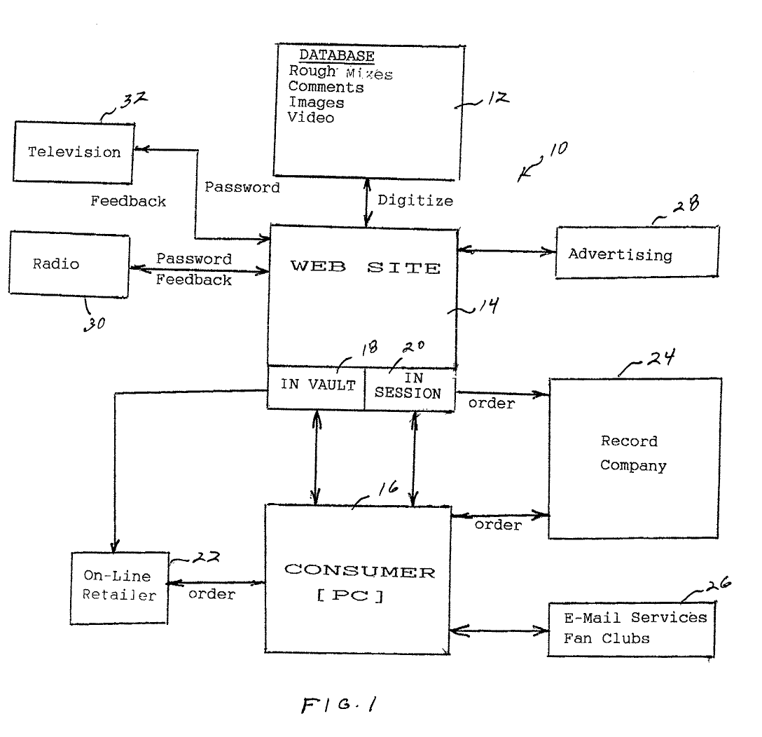

Referring to FIG. 1, there is shown at 10 the system associated with the method of the present invention for promoting the recording. The system of the present invention includes a database 12 which is interactive with a web site 14. The information contained on the database is suitably digitized for delivery by telecommunications to the server for the web site 14. The consumer 16 is suitably connected, by telecommunications equipment, to the web site 14 so as to interactively access information on the web site. In the present invention, the database includes, primarily, a selection of rough mixes. These rough mixes can be suitably categorized by style, artist, areas of interest, popularity or other techniques. Any rough mixes that have recently been included in the database can be prominently displayed. For example, when a musician has just completed a day's recording session, the availability of such a web site can be immediately displayed on the web site 14 and included on the database 12. The database can also include comments by the artist relating to the day's work or related to the recording in general. Certain images from the recording studio can also be included as part of the database. Video clips showing the performance of the musician at the recording session can also be made part of the database. The information from the database is simply digitized, in a conventional manner, so that the web site 14 can display such information in an interactive manner to the consumer 16.

The information from the database 12 can be displayed on the web site 14 as either being “in vault” 18 or “in session 20”. The “in vault” recordings 18 will include the history of rough mixes that can be accessed from the web site. Typically, these would be rough mixes associated with final recordings that are already released. As a result, the consumer 16 can access those rough mixes that are “in vault” 18 so as to see the progression and development of existing recordings. The “in session” rough mixes 20 allow the consumer to follow the development of a yet-to-be-released recording. As a result, the consumer 16 can follow the development of the final product of the musician as it is being developed. The “in session” selections 20 are for albums in production. These downloadable rough mixes will be released sequentially until the release date of the final master. The consumer 16 will be able to hear the evolution of the rough mixes toward their final form. As a result, the consumer 16 will develop a sustained, long-term invested interest in the final product.

Subsequent to listening to the recordings either “in vault” 18 or “in session” 20 from the web site 14, the consumer is allowed the opportunity to make purchasing decisions. As can be seen in FIG. 1, the consumer 16 can either order from an on-line retailer 22 or order directly from the web site 14. If an order is placed from an on-line retailer 22, the on-line retailer 22 will certainly assume the responsibility for filling the order to the consumer 16. If the recording is ordered from the web site 14, then the web site 14 will transmit the order to the record company 24 so that the record company 24 can directly fill the order of the consumer 16. Alternatively, the consumer 16 can also directly order from the record company 24. When the order is associated with an “in session” recording 20, the order to the record company 24 will simply be a pre-order. Once the final recording is released, the record company 24 will ship the recording to the consumer 16. By using the system 10 of the present invention, the consumer will be first-in-line to receive the final recording.

The web site 14 can also make information available to the consumer 16 so that the consumer 16 can receive E-mail services or join fan clubs 26. As a result, after listening to a particular artist's recordings for a certain amount of time, information by way of E-mail 26 can be delivered to the consumer 16 for information regarding further recordings by the musician.

A variety of types of advertising 28 can also be provided on the web site 14. The advertising can be displayed in a variety of ways on the web site. The advertising 28 can be delivered to the web site 14 in a static or animated manner. These banners are commonly used on various popular web sites. The advertisers will pay for the advertising space on the web site 14.

The present invention offers a unique on-line destination for music fans. The system 10 of the present invention provides a way of generating a sustained “buzz” for an upcoming release of a final recording. The present invention provides a way for the record company to create an asset from the previously unused rough mix material. The rough mix material is available for the purposes of promoting the final recording without giving the final recording away for free. The present invention is a way for on-line music fans to rate the rough mixes of the upcoming releases. The “in vault” recordings 18 are a way of generating interest in back catalog recordings. The present invention provides a potentially profitable vehicle for on-line album promotion. The present invention is very innovative to the traditional new-release media plans of record companies. The present invention also provides a technique whereby the final master can be pre-ordered so that the record companies will have an idea in advance as to the amount of success the ultimate recording will have.

A unique aspect of the present invention is also the use of radio 30 which will be interactive with the web site. The radio 30 allows that fans to listen to what has previously been the privilege of music insiders, that is, the raw, pure energy of a recording session. The radio 30 will pique the curiosity of music fans, let them sit in on the creative process and give them the exclusive first taste of what may or may not make it to the final release. The radio program 30 can be an hour-long interview-type program recorded in the studio. The radio 30 will be a program having an interview with the artist and the producer, along with the real-time creation of the rough mix from the upcoming release. The listeners to the radio 30 can be provided with a suitable password supplied by the radio affiliate during weekly promotional spots. As a result, the listener can download from the web site 14 for a limited period of time, only those rough mix created during the radio show 30. As such, the radio show 30 will be completely and truly interactive with the web site 14. The number of hits on the web site 14 will be indicative of the popularity of the radio program 30. Similarly, a television program 32 can be created. A password can be associated with the promotional aspects of the television program 32 so as to allow the viewers of the television program 32 to properly access the web site 14 for downloading the rough mixes from the television program 32. The number of hits on the web site 14 will be indicative of the popularity of the television program 32 and, as a result, provide feedback to the television program 32 and/or the web site.

The foregoing disclosure and description of the invention is illustrative and explanatory thereof. Various changes in the details of the described method can be made within the scope of the invention without departing from the true spirit of the invention. The present invention should only be limited by the following claims and their legal equivalents.

We claim:

1. A method of promoting a recording comprising:
creating a rough mix of the recordings;
digitizing said rough mix; and
inputting said digitized rough mix to a web site.

2. The method of claim 1, further comprising:
accessing said web site so as to download said digitized rough mix.

3. The method of claim 2, further comprising:
ordering the recording subsequent to said step of accessing.

4. The method of claim 3, said step of ordering comprising:
accessing said web site so as to enter an order for the recording.

5. The method of claim 3, said step of ordering comprising:
accessing an on-line retailer; and
ordering said recording from said on-line retailer.

6. The method of claim 2, further comprising:
pre-ordering the recording subsequent to step of accessing and prior to the completion of the recording.

7. The method of claim 6, said step of pre-ordering being from a record company.

8. The method of claim 1, further comprising:
storing a plurality of said rough mixes interactively at said web site.

9. The method of claim 1, said rough mix being an in-session rough mix.

10. The method of claim 1, said rough mix comprising a plurality of tracks recorded during a selected period of time.

11. The method of claim 2, said step of accessing comprising:
paying a fee during said step of accessing prior to downloading said rough mix.

12. The method of claim 1, said step of creating the rough mix comprising:
creating a radio program having said rough mix therein.

13. The method of claim 12, further comprising:
announcing a password during said radio program, said password being identifiable to an origin of said radio program.

14. The method of claim 13, further comprising:
accessing said web site with said password so as to download said rough mix from said radio program.

15. The method of claim 1, said step of creating a rough mix comprising:
creating a television program having said rough mix therein.

16. The method of claim 15, further comprising:
announcing a password during said television program, said password being identifiable to an origin of said television program.

17. The method of claim 13, further comprising:
accessing said web site with said password so as to download said rough mix from said television program.

18. The method of claim 1, said rough mix comprising comments and images and music.

19. The method of claim 1, further comprising:
forming a directory on said web site of resources for obtaining the recording.

20. The method of claim 1, the recording being a product of a record company, the method further comprising:
accessing said web site so as to download said rough mix; and
ordering said recording from said record company.
